(19) United States
(12) Patent Application Publication
(10) Pub. No.: US 2013/0066769 A1
(43) Pub. Date: Mar. 14, 2013

(54) METHODS OF DISTRIBUTED INTERVIEWING

(71) Applicants: William TRENCHARD, San Francisco, CA (US); Alexander MOORADIAN, Moraga, CA (US); Lloyd TABB, Santa Cruz, CA (US); Christopher LUNT, Mountain View, CA (US)

(72) Inventors: William TRENCHARD, San Francisco, CA (US); Alexander MOORADIAN, Moraga, CA (US); Lloyd TABB, Santa Cruz, CA (US); Christopher LUNT, Mountain View, CA (US)

(21) Appl. No.: 13/231,791

(22) Filed: Sep. 13, 2011

(51) Int. Cl. G06Q 10/06; G06Q 40/00

(52) U.S. Cl. 705/39; 705/321

(57) ABSTRACT

A distributed work force of selected candidate evaluators is used to quickly and efficiently provide multiple evaluations of a candidate for a skill position. Candidate information is provided to multiple candidate evaluators in a distributed work force. Review information is received from the multiple candidate evaluators comprising an evaluation score for one or more candidate attributes and a ranking is generated for the candidate relative to other candidates for the skill position based on the received review information.

### BACKGROUND

1. Field of the Invention

Embodiments of the present invention relate generally to the field of screening candidates for employment and, more specifically, to methods of distributed interviewing.

2. Description of the Related Art

In the field of professional recruitment, recruiting firms or employment agencies commonly locate, screen, and match job candidates for placement with an employer having an opening for a skill position. The location, screening, and matching of candidates to available skill positions are handled by a recruiter who typically performs most or all of these varied and complex actions for one particular opening. Such a process is necessarily labor-intensive. In addition, recruiters generally have little expertise in the field of the available skill position, so despite having extensive interaction with prospective candidates, a recruiter may not be able to select the most suitable candidate for a particular skill position. Consequently, the process of matching a candidate for a skill position can be cumbersome and time-consuming, while results of such a process can vary greatly from one recruiter to the next, providing inconsistent results.

In light of the above, purely automated systems have been proposed to streamline professional recruitment, where the suitability of a candidate for one or more skill positions is quantified based on answers provided in a questionnaire or interview. Such systems use little or no subjective input derived from human interaction with the candidate or human judgment when selecting suitable candidates, and can make professional recruitment faster and less labor-intensive. However, such systems perform poorly in selecting suitable candidates and frequently fail to select the most suitable candidate for an available skill position. This is because satisfaction with an employee is strongly dependent on a variety of intangible and subjective factors not readily captured by an automated system.

Accordingly, there is a need in the art for a system and method of professional recruitment that overcomes the limitations discussed above.

### SUMMARY

Embodiments of the present invention provide a method and system for evaluating a candidate for a skill position, in which a distributed work force of selected candidate evaluators is used to quickly and efficiently provide multiple evaluations of a candidate for a skill position.

According to one embodiment of the invention, a method of evaluating a candidate for a skill position includes providing candidate information to multiple candidate evaluators in a distributed work force, wherein the distributed work force comprises a plurality of candidate evaluators, receiving review information from the multiple candidate evaluators in the distributed work force, wherein the received review information comprises an evaluation score for each of multiple candidate attributes, and generating a ranking of the candidate relative to other candidates for the skill position based on the received review information.

According to another embodiment of the invention, a method of matching a skill position to a candidate comprises providing candidate information to multiple candidate evaluators in a distributed work force, wherein the distributed work force comprises a plurality of candidate evaluators, receiving review information from the multiple candidate evaluators, wherein the review information includes markers indicating desirable attributes associated with the candidate, storing the review information in a database, receiving a request to locate a candidate for a skill position, wherein the request includes desirable candidate attributes associated with the skill position, comparing the desirable candidate attributes associated with the skill position to the markers indicating desirable attributes associated with the candidate, and, based on the comparison, advancing the candidate towards being matched to the skill position at the employer.

### BRIEF DESCRIPTION OF THE DRAWINGS

So that the manner in which the above recited features of embodiments of the invention can be understood in detail, a more particular description of embodiments of the invention, briefly summarized above, may be had by reference to the appended drawings. It is to be noted, however, that the appended drawings illustrate only typical embodiments of this invention and are therefore not to be considered limiting of its scope, for the invention may admit to other equally effective embodiments.

FIG. 1 is a schematic illustration of a candidate screening system for evaluating a candidate for a skill position, according to an embodiment of the invention.

FIG. 2 is a schematic illustration of a selection process for candidate evaluators performed by a computing device, according to an embodiment of the invention.

FIG. 3 sets forth a flowchart of method steps for a candidate screening process, according to an embodiment of the invention.

For clarity, identical reference numbers have been used, where applicable, to designate identical elements that are common between figures. It is contemplated that features of one embodiment may be incorporated in other embodiments without further recitation.

### DETAILED DESCRIPTION

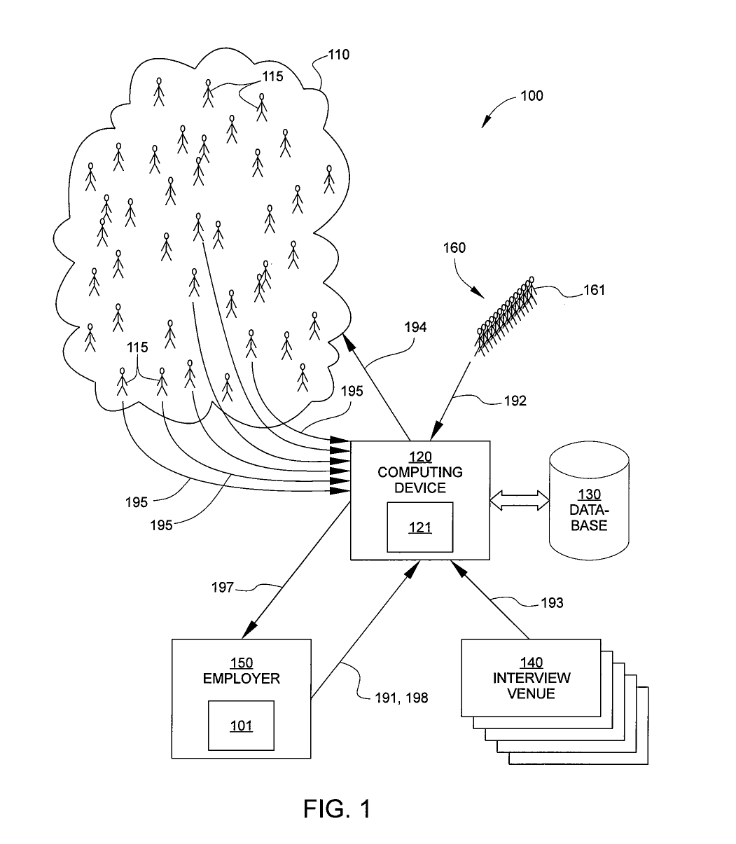

FIG. 1 is a schematic illustration of a candidate screening system 100 for evaluating a candidate for a skill position 101, according to an embodiment of the invention. Candidate screening system 100 includes a distributed workforce 110, a computing device 120, a data base 130, and, in some embodiments, one or more interview venues 140. In addition, an employer 150, a candidate pool 160, and the various elements of candidate screening system 100 are connected to each other with one or more data network systems, such as the Internet, one or more wide area networks (WANs), one or more local area networks (LANs) and the like. Candidate screening system 100 is configured to leverage the expertise of selected individuals in distributed workforce 110 to expeditiously provide high-quality, accurate evaluations of a candidate in candidate pool 160 with respect to skill position 101 that is available with employer 150.

Distributed workforce 110 is a contracted workforce that includes a plurality of candidate evaluators 115 that can access computing device 120 via the one or more data network systems described above. Because candidate evaluators 115 perform interactions in candidate screening system 100 via said data network systems, candidate evaluators 115 have no prescribed physical location relative to the various elements of candidate screening system 100 or each other. Thus, candidate evaluators 115 may be located anywhere that such network connectivity exists. To be included in distributed workforce 110, each candidate evaluator 115 undergoes a vetting process in which expertise of the candidate evaluator 115 in one or more fields is established. The fields of expertise associated with each candidate evaluator may be related to specific skill positions, general technical fields, and/or to the general evaluation of candidates for skill positions. For example, an individual candidate evaluator 115 may be established as an expert in one or more technical fields, such as software design, biotechnology, nursing, etc., as well as an expert for specific skill positions. In addition, the candidate evaluator 115 may be designated as an expert capable of performing general activities associated with evaluating candidates, including interviewing, providing qualitative assessments of, and/or performing psychological profiling of candidates.

In some embodiments, the qualifications process for candidate evaluators 115 is a fully automated process using web-based questionnaires and the like. In other embodiments, some or all of candidate evaluators 115 are themselves evaluated and selected according to embodiments of the invention described herein, i.e., using a distributed workforce of candidate evaluators substantially similar to distributed workforce 110. In yet other embodiments, an automated, questionnaire-based system is used to provide an initial group of prospective candidate evaluators, and a distributed workforce similar to distributed workforce 110 is used to make final selections from the initial group and thereby determine the candidate evaluators 115 in distributed workforce 110. Other selection methods may also be used for determining candidate evaluators 115 in distributed workforce 110 without departing from the scope of the invention.

According to some embodiments of the invention, distributed workforce 110 includes a contracted workforce, in which each candidate evaluator 115 is employed on a piece-work basis and therefore is compensated based on the individual items completed by that candidate evaluator 115. In one embodiment, an action performed by each candidate evaluator 115 is a discrete step in the overall process of evaluating and selecting one or more candidates 161 from candidate pool 160 for skill position 101. Examples of such an action performed by a candidate evaluator 115 include reviewing a resume and determining suitability of the candidate 161 for an initial screening interview; providing a qualitative assessment of a candidate 161 based on a viewing of the screening interview; assessing the technical knowledge of a candidate 161 based on questionnaire and/or interview answers; providing a determination of whether to hire the candidate; and so on. Furthermore, an action performed by a candidate evaluator 115 as part of the process of evaluating one or more candidates 161 is simultaneously made available to other candidate evaluators 115 in distributed workforce 110, and is preferably performed by several other candidate evaluators. Specifically, for a particular action in the candidate evaluation process, a request for completion is communicated to some or all eligible candidate evaluators 115 in distributed workforce 110, and the action remains available to eligible candidate evaluators 115 until a predetermined number of candidate evaluators 115 have completed the action. A more detailed description of the operation of candidate screening system 100 is provided below.

Computing device 120 comprises a central processing unit (CPU), non-volatile memory for storing persistent programs, program state, and configuration information, random access memory (RAM) for storing temporary or volatile data, and an interface to one or more of the data network systems that interconnect the various elements of candidate screening system 100. In one embodiment, computing device 120 is configured to execute an operating system as well as applications that perform selection algorithms 121 for the operation of candidate screening system 100 and the routing of data between the various elements of candidate screening system 100. Examples of selection algorithms 121 include: selection of candidate evaluators; selection of desired candidate attributes from a database; weighting of candidate evaluator ratings; and selection of candidates based on ratings provided by candidate evaluators.

Database 130 comprises one or more storage media and is configured for storing operational information for candidate screening system 100. Such operational information may include desired candidate attributes associated with skill position 191, candidate-provided information 192, candidate interview information 193, evaluation scores 195 from candidate evaluators 115, and final candidate selection information 197. Database 130 is connected to one or more of the data system networks described above to facilitate storage and retrieval of the above-described operational information for candidate screening system 100.

In some embodiments, candidate screening system 100 includes one or more interview venues 140, as illustrated in FIG. 1. In such embodiments, one or more interview venues 140 are located in each city, metropolitan area, or other geographical locale from which candidates 161 are selected. In such embodiments, candidate screening system 100 selects one or more candidates 161 from candidate pool 160 based at least in part on candidate interview data 193, where candidate interview data 193 is collected at one of interview venues 140. To facilitate the interview process, at least one Interview venue 140 is located in a city in which candidates 161 reside. In embodiments of the invention in which fully automated and/or remotely conducted interviews of candidates 161 are used to generate candidate interview data 193, interview venues 140 include a web-based video-conference room. In some embodiments, to facilitate verification of the identity of a candidate 161 being interviewed, an interview venue 140 may further include a web-connected camera with a macro-lens, so that a high-definition image of the identification credentials of a candidate 161 can be captured at the time of the interview.

Candidate pool 160 includes a plurality of candidates 161, who are individuals seeking employment in skill position 101 for which candidate screening system 100 screens candidates. Candidate pool 160 may be generated in a number of ways and still fall within the scope of embodiments of the invention. For example, candidates 161 may have registered with candidate screening system 100 individually, or they may have been actively found by candidate screening system 100 through one or more professional networks, employment websites, and the like. When a candidate is included in candidate pool 160, candidate-provided information 192, such as a resume, examples of the candidate's work product, and other pertinent information, is stored in database 130 to facilitate subsequent searching and/or dissemination by computing device 120.

In some embodiments, the performance of candidate evaluators 115 may itself be evaluated, and candidate evaluators 115 who consistently fail to provide helpful input in selecting suitable candidates may be removed from distributed workforce 110. Performance of candidate evaluators 115 may be quantified by determining which candidate evaluators 115 fail to select candidates 161 who are ultimately hired by employer 150, or who recommend candidates 161 who are ultimately rejected by employer 150.

In operation, candidate screening system 100 receives a request 198 from employer 150 for one or more qualified candidates for skill position 101 and provides recommended candidates to employer 150. Skill position 101 may be any professional, skilled, or semi-skilled job position for which professional recruiting services are retained. Request 198 includes detailed information related to skill position 101, such as location of the skill position, employee compensation, and the like. In some embodiments, in addition to request 198, candidate screening system 100 receives one or more desired candidate attributes 191 associated with skill position 101 from employer 150. Desired candidate attributes 191 may include minimum education and experience requirements, beneficial personality traits, availability for travel, specialized requirements, e.g., start-up or sales experience, and the like. In some embodiments, desired candidate attributes 191 are based on a “top-performer profile,” which includes attributes and skills of a highly successful employee currently in the skill position. In other embodiments, such desired candidate attributes for skill position 101 are automatically retrieved from database 130, where such information is stored from similar skill positions that have previously been filled using candidate screening system 100. Upon receipt of request 198, candidate screening system 100 provides one or more recommended candidates to employer 150 for skill position 101 as described below.

Candidate screening system 100 selects one or more recommended candidates 161 from candidate pool 160 by employing groups of experts made up of candidate evaluators 115. For each action in the process of screening candidates 161 from candidate pool 160, a specific group of field experts is selected from distributed workforce 110 and notified of the screening action required in order to advance request 198 to the next step in the candidate screening process. Each of the field experts is also provided the relevant candidate information 194 for completion of said screening action. Relevant candidate information 194 may include desired candidate attributes 191, candidate-provided information 192, candidate interview information 193, and in some embodiments, evaluation scores 195 that have already been provided by other candidate evaluators 115. Once a predetermined number of the selected field experts has performed the requisite screening action on each candidate being considered for a particular skill position, computing device 120 quantifies candidate suitability based evaluation scores 195 from candidate evaluators 115 and selection algorithms 121. The most suitable candidates advance to the next step in the screening process. The screening process then continues in a similar fashion through all other screening actions, e.g., interviews, psychological testing, technical knowledge evaluation, etc., until one or more of the most highly rated candidates 161 are provided to employer 150.

For example, in some embodiments, a group of candidate evaluators 115 is selected as being qualified to screen the resumes of a large number of candidates 161 for skill position 101 and evaluate which particular candidates 161 should be advanced to the next step in the screening process, e.g., being interviewed. Each candidate evaluator 115 evaluates candidate resumes until each candidate resume has been evaluated by a predetermined number of candidate evaluators 115, e.g., 3, 5, 10, etc. The evaluations of each resume are then tallied and aggregated, and candidates 161 with the highest-scoring resumes are advanced to the next step in the screening process. In some embodiments, the predetermined number of evaluations is equal to the number of qualified candidate evaluators 115 selected. Consequently, in such an embodiment, each of the candidate evaluators 115 qualified to screen the candidate resumes is required to provide an evaluation of each candidate resume. In other embodiments, the total number of eligible candidate evaluators 115 is substantially greater than the predetermined number of evaluations desired for each resume, and a particular eligible candidate evaluator 115 may provide an evaluation for some, none, or all of the candidate resumes selected for screening. Advantages of such an embodiment are twofold. First, the current screening action, i.e., resume review, can be completed for a large number of candidates 161 in an especially short time, since a large number of candidate evaluators 115 can be qualified to participate in the current screening action. Second, because the subjective assessments from a predetermined number of multiple individuals are averaged together for a specific screening action, results of the process described herein are generally more consistent and also more likely to accurately anticipate the desires of employer 150. This is because the results of a conventional screening process are typically subject to wide variation, since human factors play such an important role in the selection of a suitable candidate for a skill position. In contrast, embodiments of the invention leverage the “wisdom of the crowd” by incorporating the viewpoints of multiple field experts with respect to each candidate 161.

A candidate evaluator 115 may be considered a field expert and therefore qualified to perform a particular screening action by virtue of one or more criteria, including: 1) having first-hand experience in a similar skill position to skill position 101; 2) having first-hand experience as a manager of a skill position similar to skill position 101; 3) by having general experience in a discipline to which skill position 101 is related; and 4) having experience in performing the specific screening action, e.g., psychological profiling, interviewing, etc. Distributed workforce 110 includes a large number of candidate evaluators 115 who together are qualified as field experts for a large number of disciplines. Because distributed workforce includes so many candidate evaluators 115, at least some qualified candidate evaluators are available to participate a screening action at any time, and work on the screening action can begin immediately.

Considering the large number of different fields and skill positions that benefit from professional recruiting, it is generally impractical to employ experienced field experts as full-time recruiters for any particular field or skill position. Consequently, technical recruiters typically lack any technical experience in the fields in which they screen candidates, which can be a significant drawback for the evaluation of candidates of for many skill positions. Unlike the prior art, candidate screening system 100 leverages the experience of a relatively large number of expert candidate evaluators 115, thereby applying the human judgment necessary to select a suitable candidate for skill position 101. According to embodiments of the invention, the human judgment relied upon is that of individuals having significant relevant experience; this human judgment is further enhanced by being derived from multiple field experts, i.e., the “wisdom of the crowd” at each step in the candidate screening process.

As noted above, for a particular action in the candidate screening process, each candidate 161 is evaluated by a predetermined number of candidate evaluators 115. Ideally, the predetermined number is the smallest number of candidate evaluators 115 necessary to mitigate extremes that may be generated by any one candidate evaluator 115. The predetermined number may be different for each screening action in the candidate screening process, and may be determined based on a number of factors. In some embodiments, the predetermined number is fixed. In other embodiments, the predetermined number may be altered based on the suitability of previously presented candidates to a particular employer or for a particular category of skill position. For example, if an undesirable percentage of candidates 161 presented to employer 150 for a previous skilled position were not ultimately hired by employer 150, the predetermined number of evaluations desired for one or more screening actions may be increased. In some embodiments, the predetermined number may vary based on what particular skill position or employer candidates 161 are being screened for. For example, for less technical skill positions, evaluation of candidates 161 may include more qualitative assessment of candidates 161, and evaluations from a larger number of candidate evaluators 115 may be desirable for each screening action in the candidate screening process. In some embodiments, the predetermined number is as small as three and in other embodiments is ten or larger.

At each step in the candidate screening process for skill position 101, candidate evaluators 115 provide evaluation scores 195 to computing device 120 for candidates 161. Evaluation score 195 may be based on any technically feasible evaluation quantification method and fall within the scope of the invention. For example, in some embodiments, a simple binary result may be used for one or more screening actions in the candidate screening process, i.e., “yes” and “no.” In some embodiments, a ternary result may be provided by each candidate evaluator: “yes,” “no,” or “maybe.” In other embodiments, higher granularity of output from each candidate evaluator 115 can be provided by using a 5-point scale, a 10-point scale, or a sliding scale, such as a graphical user interface (GUI) based slider, which has an almost unlimited number of selectable values between a highest possible value and a lowest possible value. Other technically feasible evaluation quantification methods may also be used by candidate evaluators 115 in rating each candidate 161 without departing from the scope of the invention.

In some embodiments, a different weighting factor is applied to evaluation score 195 from each candidate evaluator 115 when evaluation information from all candidate evaluators 115 is tallied and averaged. In some embodiments, the weighting factor for a particular candidate evaluator 115 depends on the evaluation history of that candidate evaluator 115. For example, in one embodiment, the weighting factor is used to normalize any historical bias displayed by a particular candidate evaluator 115. Specifically, when a particular candidate evaluator 115 has a history of providing more “yeses” than other candidate evaluators do on average, the value of a “yes” vote by that candidate evaluator 115 is given less weight when all evaluation scores 195 are processed. In another embodiment, the weighting factor can be adjusted based on how often the candidate evaluator 115 provides “yeses” or “noes.” To wit, the more often a candidate evaluator 115 provides “yeses” for candidate evaluations, the less weight is given to “yeses” provided by that particular candidate evaluator. Other weighting factor schemes can be applied in addition to or in lieu of the above weighting schemes as well. For example, evaluation score 195 from a particular candidate evaluator 115 can be weighted as a function of how much time the candidate evaluator 115 spent on a specific evaluation, or how successfully the particular candidate evaluator 115 has selected candidates 161 for previous skill positions.

In some embodiments, the effectiveness of distributed workforce 110 is enhanced via a “social activity feed” in which recent activity related to a particular job skill 101 is provided to candidate evaluators 115 during the candidate scanning process. In one embodiment, updated information from employer 150 related to job skill 101 is communicated to candidate evaluators 115, such as the suitability of the most recently recommended candidates or changes in the description of skill position 101. Feedback from employer 150 to distributed workforce 110 regarding previously recommended candidates allows distributed workforce to become “smarter” and better able to select suitable candidates going forward. In other embodiments, output of candidate evaluators 115 with respect to skill position 101, such as evaluation scores 195, is communicated to all candidate evaluators qualified to participate in screening for skill position 101. Consequently, individuals making up distributed workforce 110 are not operating in an information vacuum, and can more efficiently focus effort on the highest quality candidates 161.

In some embodiments, the order in which candidates 161 are made available to candidate evaluators 115 for evaluation is based on evaluation scores 195 received from previous candidate evaluators 115. For example, in one embodiment, a plurality of candidates 161 being screened for skill position 101 are each given a priority ranking based on evaluation scores 195 already provided by one or more of the candidate evaluators 115 qualified to evaluate candidates 161. The priority ranking adjusts the order in which each candidate 161 is made available for evaluation by the remaining candidate evaluators 115 who have not yet evaluated candidates 161. In such an embodiment, candidates 161 receiving higher evaluation scores 195 are the first candidates to be screened by the remaining candidate evaluators 115. In this way, feedback from other evaluators can be used to accelerate the screening process, thereby minimizing time focused on less-suitable candidates for greater overall efficiency in the selection process.

In some embodiments, use of distributed workforce 110 differs from the well-known concept of “crowd sourcing,” in that only vetted or preselected individuals from distributed workforce 110 are eligible to perform a specific screening action in the candidate screening process. Thus, in such embodiments, an “open call,” which characterizes true crowd sourcing, does not take place; an open call relies on broadcasting a production or problem-solving request to an unknown, undefined, group of participants. Further, each screening action that makes up the recruiting process may be assigned to a different sub-group of candidate evaluators 115 from the distributed workforce, thereby creating what is essentially a “virtual assembly line” for evaluating a plurality of candidates for a particular skill position. Specifically, the candidate screening process is broken down into individual actions, where each individual action is performed by a different group of candidate evaluators having a different skill set or area of expertise. Because each step of the candidate screening process is performed separately and by a different and specialized group of candidate evaluators 115, suitable candidates can be selected more quickly and with more consistency than when a single recruiter performs all steps of the candidate screening process. In addition, such candidate selections are based on the viewpoints of multiple individuals who are also field experts, rather than on the opinion of a single recruiter who generally has no technical experience in the field of the skill position.

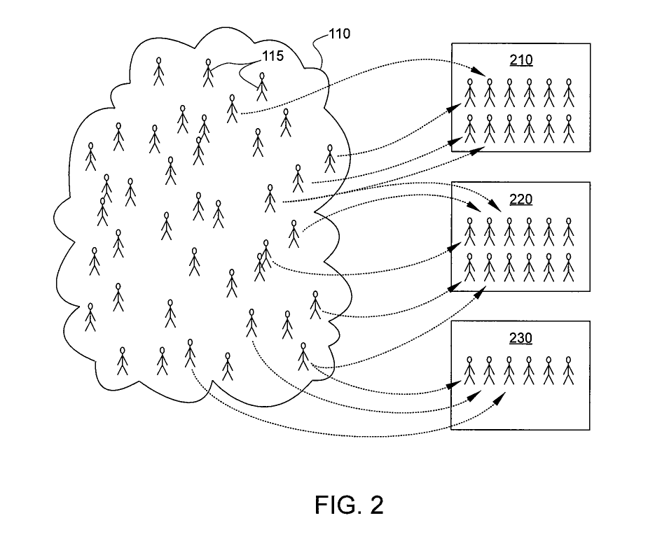

FIG. 2 is a schematic illustration of a selection process 200 for candidate evaluators 115 performed by computing device 120, according to an embodiment of the invention. Selection process 200 is used in some embodiments of the invention to select candidate evaluators 115 for one or more different screening actions performed by candidate screening system 100. As shown, candidate evaluators 115 are selected from distributed workforce 110 to form the different groups 210, 220, 230 of candidate evaluators desired for candidate screening system 100 to complete the candidate-screening process. In the embodiment illustrated in FIG. 2, three groups of candidate evaluators 115 are depicted: a group 210 of field experts, a group 220 of qualitative assessment evaluators, and a group 230 of psychological evaluation experts. Other groups of candidate evaluators 115 may be selected for different screening actions without departing from the scope of embodiments of the invention.

In a preferred embodiment, candidate evaluators 115 are selected from distributed workforce 110 via an automated process performed by computing device 120. The candidate evaluators 115 are selected based on one or more selection criteria, such as area of expertise of each candidate evaluator 115, success rate of each candidate evaluator 115 in selecting candidates 161 who are ultimately hired, total number of candidate evaluators desired for each group, and the like.

Group 210 includes a plurality of field experts who are qualified to perform screening actions related to the technical expertise of a candidate 161, such as resume screening and rating of interview performance. Group 220 includes a plurality of candidate evaluators 115 deemed qualified to perform qualitative assessment of candidates. For example, the members of group 220 may view recorded interviews of candidates 161 or portions of interviews, such as a “highlights reel” for each candidate. Group 220 may be tasked with evaluating more subjective aspects of a candidate's suitability for a skill position, such as, “Is the candidate confident?” Group 230 includes a plurality of candidate evaluators 115 qualified to perform one or more psychological evaluations of candidates 161 based on interviews or excerpted interviews. For example, group 230 may be responsible for determining if a candidate has a personality type compatible with a desired work environment or employer and/or if a candidate is lying at certain points in the interview. It is noted that in some cases, a candidate evaluator 115 may be selected for more than one of groups 210, 220, and 230.

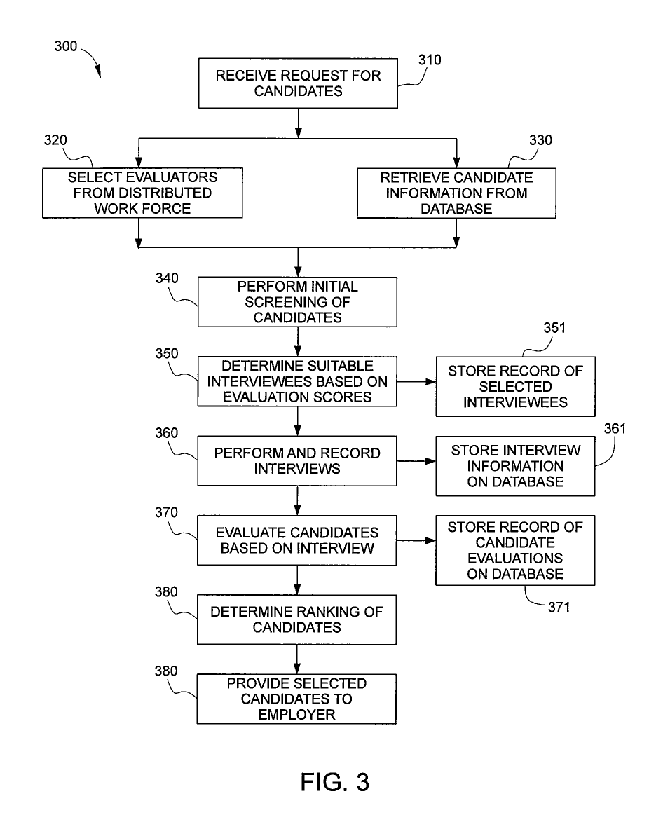

FIG. 3 sets forth a flowchart of method steps for a candidate screening process 300, according to an embodiment of the invention. Although the method steps are described with respect to candidate screening system 100, persons skilled in the art will understand that performing the method steps, in any order, to select one or more candidates for a skill position is within the scope of embodiments of the invention.

The method 300 begins in step 310, in which a processor within computing device 120 executing a candidate screening application receives request 198 from employer 150 for one or more qualified candidates for skill position 101. In some embodiments, one or more desired candidate attributes 191 associated with skill position 101 are also received from employer 150. In other embodiments, candidate screening system 100 retrieves desired candidate attributes 191 from database 130 based on similarities between skill position 101 and skill positions previously handled by candidate screening system 100.

In step 320, the processor selects a group of candidate evaluators 115 for each desired screening action in the screening process, e.g., groups 210, 220, and 230 in FIG. 2. In a preferred embodiment, the number of candidate evaluators 115 in a particular group far exceeds the desired number of evaluations to be performed in the corresponding screening action. For example, five evaluations of each resume may be desired in a specific embodiment of the invention, but the number of candidate evaluators 115 selected in step 320 to be eligible to perform such a resume evaluation may be on the order of dozens or even hundreds. In one embodiment, the candidate evaluators 115 included in the distributed workforce 110 are not directly employed by employer 150.

In step 330, the processor retrieves candidate-provided information 192 from database 130. As noted above, candidate-provided information 192 may include a resume, examples of the candidate's work product, and other pertinent information, such as a candidate-edited video. In some embodiments, step 330 is performed concurrently with step 320.

In step 340, candidates 161 are screened for suitability for being interviewed. The screening process in step 340 is performed by a suitable group of candidate evaluators 161 selected in step 320. Evaluation scores 195 provided by each candidate evaluator 115 may be based on a binary output, a ternary output, a 5-point scale, a 10-point scale, a sliding scale, and the like. Each evaluation score 195 provided by each candidate evaluator 115 may include an evaluation score for each of multiple candidate attributes. In some embodiments, each evaluation provided by a candidate evaluator 115 affects the order in which candidate-provided information 192 of the evaluated candidate 161 is made available to subsequent candidate evaluators 115. Thus, in step 340, higher-scoring candidates 161 are evaluated by subsequent candidate evaluators 115 sooner than lower-scoring candidates 161.

In step 350, the processor determines which candidates 161 are eligible to be interviewees based on evaluation scores 195 provided in step 340. As noted previously, evaluation scores 195 may be weighted in a variety of ways according to different embodiments of the invention. Step 350 may be an automated process performed by computing device 120 using selection algorithms 121 as described herein.

In step 351, the processor stores a record of candidates 161 determined to be suitable for an initial interview in step 350 in database 130. The record stored in step 351 can be accessed for the selection of candidates for future skill positions.

In step 360, each interviewee selected in step 350 participates in an interview in a suitable interview venue 140. The interview may include a face-to-face interviewer or a video-conferenced interviewer, or may be fully automated process. The interview is recorded, and, in step 361, the processor stores the candidate interview information 193 to database 130 for future reference. In some embodiments, candidate interview information 193 may include portions of the interview recorded in step 360 that the interviewee considers to be most representative of the candidate. In such an embodiment, the highlights reel may be of a specified brief duration, e.g. 1 minute, 3 minutes, etc.

In step 370, candidates 161 are screened for the next step of the candidate selection process based on candidate interview information 193. In one embodiment, the screening that takes place in step 370 includes a qualitative assessment of each interviewee. In other embodiments, the screening that takes place in step 370 includes a technical assessment of the interviewee's knowledge pertinent to skill position 101. Evaluation scores 195 are provided by each candidate evaluator 115, and, in step 371, the processor stores the evaluation scores 195 in database 130 for future reference. In some embodiments, each candidate evaluator 115 may bookmark portions of each interview to facilitate the generation of an evaluator highlight reel. In such an embodiment, evaluator highlight reels are also stored in database 130. In some embodiments, a single highlight reel may be assembled for each interviewee from the highlight reels generated in step 370.

In step 380, the processor determines a rank or score of each interviewee using selection algorithms 121, as described herein. For example, weighting of each evaluation score 195 based on characteristics and/or past performance of each candidate evaluator 115 may be included in the performance of step 380.

In step 390, the processor provides final candidate selection information 197 to employer 150. In some embodiments, candidate selection information 197 includes the resume, contact information, and highlight reels associated with one or more of the highest-scoring candidates 161 determined in step 380.

It is noted that candidate screening method 300 is intended as an exemplary embodiment of the invention, and the specific screening actions described therein are representative of only one embodiment of the invention. For example, in some embodiments, multiple interviews may be part of the candidate screening process, including one interview focused on technical knowledge of the candidate and another interview that focuses on other skill sets, personality, etc. Additional screening actions or different combinations of screening actions may also be part of a candidate screening process, according to embodiments of the invention.

In sum, embodiments of the invention provide a method and system for evaluating a candidate for a skill position in which a distributed work force of selected candidate evaluators is used to quickly and efficiently provide evaluations of a candidate. Advantages of the invention include the fast and efficient leveraging of highly-skilled personnel as evaluators of potential candidates. Also, a large number of evaluators can be selected who have technical experience directly related to the skill position in question. In addition, the more reliable results provided by multiple, experienced evaluators is combined with the time efficiency of a virtual assembly line, in which one complex task is performed in discrete parts. Further, embodiments of the invention have no need of significant local infrastructure and/or personnel to obtain the kind of subjective and behavioral information essential for selecting the most suitable candidates.

Various embodiments of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

While the foregoing is directed to embodiments of the present invention, other and further embodiments of the invention may be devised without departing from the basic scope thereof, and the scope thereof is determined by the claims that follow.

1. A method of evaluating a candidate for a skill position at an employer, the method comprising:
providing candidate information to at least one candidate evaluator in a distributed workforce, wherein candidate evaluators included in the distributed workforce are not employed by the employer and are not affiliated with each other in a professional capacity;
receiving review information from the at least one candidate evaluator, wherein the received review information comprises an evaluation score for each of one or more candidate attributes; and
generating a ranking corresponding to the candidate relative to other candidates for the skill position based on the received review information.

2. The method of claim 1, wherein the provided candidate information comprises at least one of a recorded interview of the candidate, a candidate-defined highlight video based on the recorded interview of the candidate, a real-time interview with the candidate, examples of the candidate's work product, and the candidate's resume.

3. The method of claim 1, further comprising creating a highlight reel of a recorded interview with the candidate.

4. The method of claim 3, wherein the highlight reel is based on inputs from the at least one candidate evaluator.

5. The method of claim 1, wherein generating a ranking of the candidate comprises applying a predetermined weighting factor based on a top-performer profile to at least one evaluation score received from the at least one candidate evaluator.

6. The method of claim 1, wherein the at least one candidate evaluator is selected from the distributed work force based on at least one of the skill position and past performance of the at least one candidate evaluator.

7. The method of claim 1, wherein receiving review information from the at least one candidate evaluator comprises assigning a priority of the candidate based on the review information received from the at least one candidate evaluator, the priority adjusting the order in which the candidate is evaluated by at least one subsequent candidate evaluator.

8. The method of claim 1, further comprising providing monetary compensation to the at least one candidate evaluator for generating the review information on a piece-work basis.

9. The method of claim 8, wherein providing monetary compensation on a piece-work basis comprises compensating the at least one candidate evaluator based on an individual item completed by the at least one candidate evaluator.

10. The method of claim 1, further comprising selecting at least one candidate evaluator in the distributed workforce to act as an interviewer of the candidate or as an editor of a highlight reel of a recorded interview of the candidate.

11. A non-transitory computer-readable storage medium storing instructions that, when executed by a processor, cause a computer system to evaluate a candidate for a skill position at an employer, by performing the steps of:
providing candidate information to at least one candidate evaluator in a distributed work force, wherein candidate evaluators included in the distributed workforce are not employed by the employer and are not affiliated with each other in a professional capacity;
receiving review information from the at least one candidate evaluator, wherein the received review information comprises an evaluation score for each of one or more candidate attributes; and
generating a ranking corresponding to the candidate relative to other candidates for the skill position based on the received review information.

12. The non-transitory computer-readable storage medium of claim 11, wherein the provided candidate information comprises at least one of a recorded interview of the candidate, a candidate-defined highlight video based on the recorded interview of the candidate, a real-time interview with the candidate, examples of the candidate's work product, and the candidate's resume.

13. The non-transitory computer-readable storage medium of claim 11, further comprising instructions that, when executed by a processor, cause the computer system to perform the step of creating a highlight reel of a recorded interview with the candidate.

14. The non-transitory computer-readable storage medium of claim 13, wherein the highlight reel is based on inputs from the at least one candidate evaluator.

15. The non-transitory computer-readable storage medium of claim 11, wherein generating a ranking of the candidate comprises applying a predetermined weighting factor based on a top-performer profile to at least one evaluation score received from the at least one candidate evaluator.

16. The non-transitory computer-readable storage medium of claim 11, wherein the at least one candidate evaluator is selected from the distributed work force based on at least one of the skill position and past performance of the at least one candidate evaluator.

17. The non-transitory computer-readable storage medium of claim 11, wherein receiving review information from the at least one candidate evaluator comprises assigning a priority of the candidate based on the review information received from the at least one candidate evaluator, the priority adjusting the order in which the candidate is evaluated by at least one subsequent candidate evaluator.

18. The non-transitory computer-readable storage medium of claim 11, further comprising instructions that, when executed by a processor, cause the computer system to perform the step of providing monetary compensation to the at least one candidate evaluator for generating the review information on a piece-work basis.

19. The non-transitory computer-readable storage medium of claim 18, wherein providing monetary compensation on a piece-work basis comprises compensating the at least one candidate evaluator based on an individual item completed by the at least one candidate evaluator.

20. The non-transitory computer-readable storage medium of claim 11, further comprising instructions that, when executed by a processor, cause the computer system to perform the step of selecting at least one candidate evaluator in the distributed workforce to act as an interviewer of the candidate or as an editor of a highlight reel of a recorded interview of the candidate.

21. A method of matching a skill position at an employer to a candidate, the method comprising:
providing candidate information to at least one candidate evaluator in a distributed work force, wherein candidate evaluators included in the distributed work force are not employed by the employer and are not affiliated with each other in a professional capacity;
receiving review information from the at least one candidate evaluator, wherein the review information includes markers indicating desirable attributes associated with the candidate;
storing the review information in a database;
receiving a request to locate a candidate for a skill position, wherein the request includes desirable candidate attributes associated with the skill position;
comparing the desirable candidate attributes associated with the skill position to the markers indicating desirable attributes associated with the candidate; and
based on the comparison, advancing the candidate towards being matched to the skill position at the employer.

22. The method of claim 21, wherein receiving review information from the at least one candidate evaluator comprises assigning a priority of the candidate based on the review information received from the at least one candidate evaluator, the priority adjusting the order in which the candidate is evaluated by at least one subsequent candidate evaluator.

23. The method of claim 21, further comprising creating a highlight reel of a recorded interview with the candidate.

24.-26. (canceled)

27. The method of claim 23, wherein the highlight reel is based on inputs from the at least one candidate evaluator.

28. The method of claim 21, further comprising providing monetary compensation to the at least one candidate evaluator for generating review information on a piece-work basis.

29. The method of claim 21, wherein advancing the candidate comprises selecting the candidate to participate in an interview process for the skill position.

30. The method of claim 21, wherein the review information comprises at least one of a recorded interview of the candidate, a highlight video based on the recorded interview of the candidate, examples of the candidate's work product, and the candidate's resume.
